(19) United States
(12) Patent Application Publication
(10) Pub. No.: US 2022/0245043 A1
(43) Pub. Date: Aug. 4, 2022

(54) DATA STORAGE SYSTEM WITH DECENTRALIZED POLICY ANALYSIS

(71) Applicant: Seagate Technology LLC, Fremont, CA (US)

(72) Inventors: Michael V. Jones, Scotts Valley, CA (US); Corey Hill, Broomfield, CO (US); Carol Joy Gray, El Cerrito, GA (US)

(21) Appl. No.: 17/248,570

(22) Filed: Jan. 29, 2021

(51) Int. Cl. G06F 11/30; G06F 11/32; G06F 12/14; G06F 21/57

(52) U.S. Cl. CPC G06F 11/3037; G06F 11/323; G06F 2212/1052; G06F 21/577; G06F 2212/1024; G06F 12/14

(57) ABSTRACT

A data storage system may track data access operations to a memory with a distribution module and translate the tracked data access operations into at least one activity with the distribution module. The distribution module generates a decentralization strategy and then creates a first visual representation of the at least one activity and a second visual representation of the at least one activity with the distribution module. The respective visual representations are distributed to a first user and a second user with the first user and second user respectively selected by the decentralization strategy for analysis for a purpose assigned by the decentralization strategy.

### SUMMARY

The present disclosure is generally directed to distributing data storage system information to users for analysis and operational policy alteration.

Various Embodiments of a data storage system track data access operations to a memory with a distribution module and translate the tracked data access operations into at least one activity with the distribution module. The distribution module generates a decentralization strategy and then creates a first visual representation of the at least one activity and a second visual representation of the at least one activity with the distribution module. The respective visual representations are distributed to a first user and a second user with the first user and second user respectively selected by the decentralization strategy for analysis for a purpose assigned by the decentralization strategy.

In other embodiments of a data storage system, a tracking strategy is generated by a distribution module to allow the tracking of data access operations to a memory before translating the tracked data access operations into at least one activity. The distribution module generates a display strategy to allow the creation of a first visual representation of the at least one activity and a second visual representation of the at least one activity that are each distributed to respective first and second users selected by the distribution module. An analysis strategy is generated by the distribution module to provide a first analysis purpose that is assigned to the first user and a second analysis purpose that is assigned to the second user.

A data storage system, in some embodiments, tracks data access operations to a memory with a distribution module before translating the tracked data access operations into at least one activity. A first visual representation of the at least one activity and a second visual representation of the at least one activity is created with the distribution module and distributed to respective first and second users selected by the distribution module. The first visual representation is analyzed by the first user for a first purpose assigned by the distribution module and the second visual representation is analyzed by the second user for a second purpose assigned by the distribution module. The first purpose is altered to a third purpose in response to a change in the tracked data access operations with the third purpose being different than each of the first and second purposes.

### BRIEF DESCRIPTION OF THE DRAWINGS

FIG. 1 provides a functional block representation of a data storage system in which various embodiments can be practiced.

FIG. 2 shows aspects of an example data storage device arranged in accordance with some embodiments.

FIG. 3 shows a block representation of portions of an example data storage system configured in accordance with some embodiments.

FIG. 4 illustrates an example activity view compiled from a data storage system in assorted embodiments.

FIG. 5 depicts a block representation of an example distribution module that can be employed in various embodiments of a data storage system.

FIG. 6 is a timeline of an example workload procedure that may be conducted in a system in accordance with assorted embodiments.

FIG. 7 depicts a block representation of portions of an example data storage system utilized in accordance with some embodiments.

FIG. 8 is a flowchart of an example activity analysis routine that can be carried out with the embodiments of FIGS. 1-7.

### DETAILED DESCRIPTION

A data storage system, in accordance with assorted embodiments, employs circuitry to intelligently distribute activity analysis to users and/or hosts to provide optimal, decentralized system performance and resource allocation.

As the generation, transmission, and storage of data has grown, the management and tracking of data has failed to mature and evolve. The result of rudimentary data tracking, along with crude tracking of data storage activity, is degraded system performance, decreased system availability, and increased system volatility. By using static activity tracking policies and centralized activity analysis, a data storage system is forced to allocate system resources that would otherwise be used for data storage and retrieval, which can degrade system performance and jeopardize system security. Hence, various embodiments provide sophisticated system and data activity tracking with dynamic policies that allow for decentralized analysis of tracked activity and optimized data storage performance, reliability, and security.

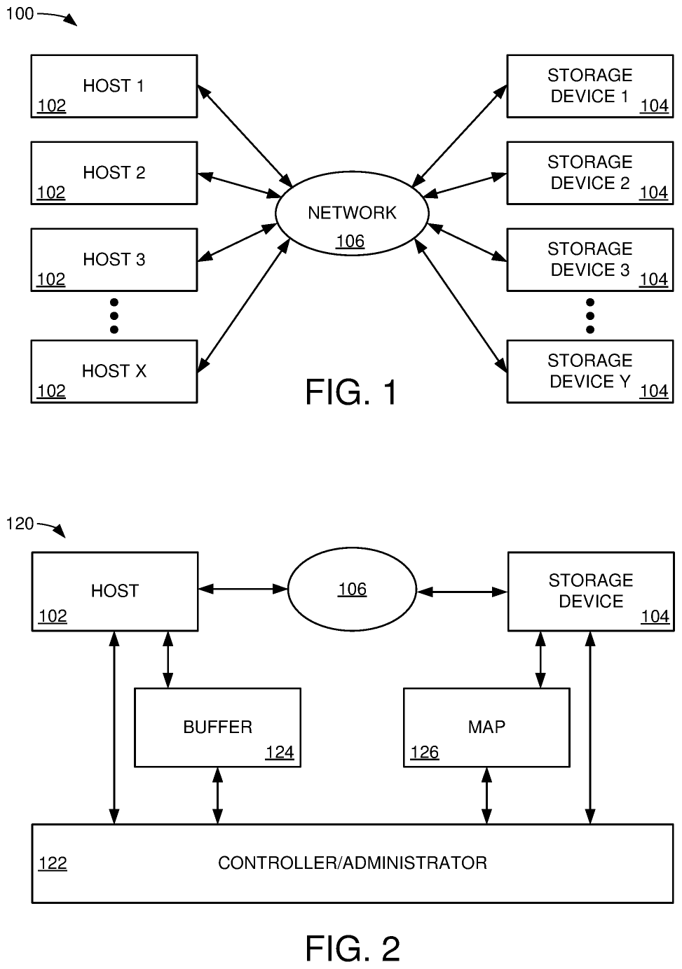

Turning to the drawings, FIG. 1 depicts a block representation of an example data storage system 100 in which assorted embodiments are practiced. The system 100 connects any number (X) of hosts 102 to any number (Y) data storage devices 104 via one or more wired and/or wireless networks 106. The various hosts 102 can be positioned in any location with any type, performance, and capability to create, transfer, and receive data stored in one or more data storage devices 104. The assorted data storage devices 104 are not limited to a uniform configuration and can have any capacity, performance capability, and type of memory to store data. It is contemplated that the respective data storage devices 104 employ non-volatile memory, such as solid-state memory cells and/or rotating magnetic media.

With the assorted hosts 102 respectively creating data and/or data access requests to the data storage devices 104, separate ownership, security, compression, encryption, and mapping may be used. Such separate, and potentially different, data and data access configurations emphasize accurate tracking of data, data accesses, and the memory in which data is stored. However, greater numbers of hosts 102, and more sophisticated separate data configurations, correspond with inefficient system 100 activity tracking. In addition, system activity tracking has traditionally been available only to system administrators and in formats that do not intelligently convey the status, performance, and/or vulnerabilities of data, hosts 102, or data storage devices 104.

FIG. 2 depicts a block representation of portions of an example data storage system 120 arranged to provide data and system activity tracking in accordance with some embodiments. A single host 102 is shown connected to a single data storage device 104 that employs at least one non-volatile memory, but such arrangement is not limiting or required as additional hosts 102, data storage devices 104, and network interconnections 106 can be employed concurrently and sequentially. Each system 120 host 102 and data storage device 104 is connected to at least one activity controller 122 that services as an administrator of policies dictating how data is stored, retrieved, and maintained.

The activity controller 122 can selectively utilize one or more buffers 124 to temporarily store data flowing back and forth between hosts 102 and data storage devices 104. It is contemplated that the activity controller 122 can select between more than one buffer 124 data repository, such as different volatile and/or non-volatile memories with different data access latencies, error rates, physical sizes, and/or storage capacities. As data flows to the data storage device 104, a map module 126 is activated by the activity controller 122 to describe at least the logical and physical locations of data in memory of the device 104.

In response to data generated by the host 102 being stored in the data storage device 104 and/or data stored in the data storage device 104 being accessed by the host 102, the activity controller 122 logs various status, performance, and vulnerability metrics. For instance, the controller 122 can monitor, track, and log, the initial request for data storage, or retrieval, the overall time to carry out the request, the error rate of data accesses to the data storage device 104, the location of data in the memory of the data storage device 104, the compression of stored data, the number of accesses to the physical memory cells of the data storage device 104, the number of accesses to the data currently stored in the data storage device 104, the background operations conducted on the data, and the owners of the assorted requests for the data in the data storage device 104. While monitoring and logging these, and other, system activities and metrics can be useful for the activity controller 122 to organize data, pending data access requests, and logical units, such as garbage collection units, namespaces, and/or containers, the addition of multiple hosts 102 and/or data storage devices 104 quickly jeopardizes overall system performance by tracking and logging various system activities and metrics, particularly when different hosts 102 have sophisticated and/or different ownership, performance guarantees, and/or data configurations.

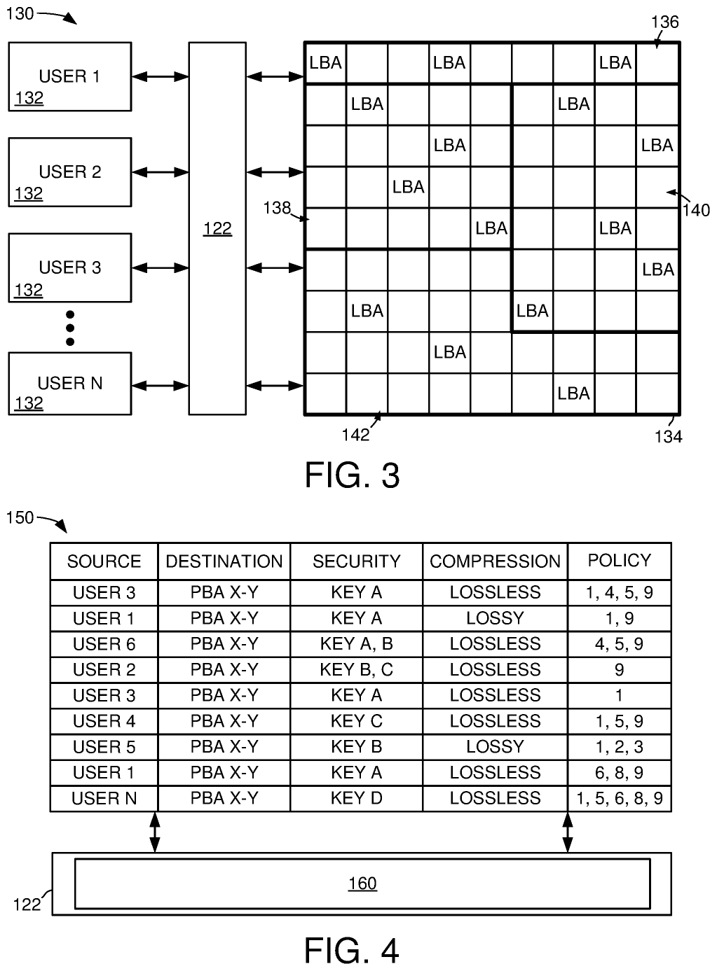

FIG. 3 conveys portions of an example data storage system 130 in which an activity controller 122 carries out various embodiments of system activity and metric tracking. The activity controller 122 can direct operations from any number of users 132, which can be human or other non-computing entity acting as a host for access to a data repository 134. The data repository 134 is visually shown in FIG. 3 as a continuous grid of logical block addresses (LBA), but can be any number of different memories resident in different data storage devices. For example, the constituent repository LBAs can correspond with physical block addresses (PBA) located in separate data storage devices and memories located in different locations, such as different cities, countries, and/or continents.

It is noted that various portions of the data repository 134 can be logically divided into one or more units, such as namespaces, garbage collection units (GCU), calibration groups, containers, and partitions. One or more data storage controllers can allocate the various logical and physical aspects of the data repository 134 over time to provide sufficient data reliability, security, and availability. A storage controller can execute one or more operational policies that dictate how, where, and when data is stored and retrieved. For instance, operational policies can dictate what can access data once stored (ownership), what can update stored data, how data is compressed, what encryption is applied to data (security), and what logical and/or physical addresses are available for data.

In the non-limiting example of FIG. 3, a first user has data stored in a namespace 136 that the first user has exclusive ownership while data from a second user is stored redundantly in multiple different namespaces 138 & 140. Portions of data from a third user can be temporarily, or permanently, stored in addresses 142 dedicated to shared storage for any connected user. With the various operational policies in place and, potentially, providing different parameters for how data is handled, where data is stored, and when data can be accessed, the activity controller 122 can detect, log, and track the execution of the assorted operational policies. That is, the activity controller 122 can log at least how data is stored/retrieved, when data is stored/retrieved, where data is stored/retrieved, and who requested access to data. It is noted that the activity controller 122 may additionally monitor and track operations to memory cells that are not initiated by user/host requests, such as cell calibrations, garbage collections, mapping, error correction, and allocation of memory for overprovisioning.

Although tracking data accesses and memory cell operations can be conducted by the activity controller 122, the presence of numerous different users 132 having different volumes of activity associated with different data ownerships, security, and permissions can degrade data access performance of the data storage system 130. As a result of heightened volume and/or complexity of system acidity, the activity controller 122 may be slowed or suspended to preserve data access performance, which jeopardizes the accuracy of tracked operations and the ability of the controller 122 to provide current status, statistics, and performance that can be used to optimize speed, reliability, and/or security of data accesses.

The complexities and operational volatility associated with tracking activity from multiple different users 132 can be exacerbated by static activity tracking policies that dictate how and what the activity controller 122 monitors and logs for tracking. Accordingly, various embodiments are directed to intelligently altering tracking controller 122 operational policies to provide accurate and efficient status of system activity without degrading average or peak data access performance for the system 130.

Through dynamic activity tracking operational policies, tracked parameters, status, statistics, and performance can be intelligently formatted, analyzed, and displayed to authorized users, administrators, and hosts to allow a distribution of tracked information and a reduction in time and processing resources needed to translate the tracked information into data access operational parameter changes that can optimize the performance of the system 130. By correlating current, pending, and predicted workloads to various logical units, such as namespaces, containers, and GCUs, the activity controller 122 can intelligently operate with policies selected to provide accurate tracking without degrading the actual and/or potential data access performance to the data repository 134.

FIG. 4 depicts a block representation of portions of control dashboard 150 that is compiled, analyzed, and conveyed by an activity controller monitoring at least one memory connected to one or more users/hosts. It is noted that the various information conveyed in the dashboard 150 is not limiting or required as the dashboard 150 can be configured by an activity controller 122 to show any detected and predicted operational parameter, statistic, and performance for any aspect of a data storage system. The example view of FIG. 4 displays how various information can be compiled into a chronological list with the source of the activity, destination of any data movement, operational policies conducted, and operational statistics involved, as well as the status, workload, and performance of the involved memory cells and/or logical unit.

It is noted that the compilation of the various metrics and tracked operational parameters can be resource and time intensive for the activity controller, particularly when different users concurrently conduct data accesses to different memories with different operational policies and permissions. It is further noted that the compilation of tracked metrics and/or performance, such as the view shown in FIG. 4, can be more resource and time intensive than if raw tracked data is logged and depicted. Hence, embodiments of the activity controller can control the expenditure of system resources by altering what information is tracked, how tracked information is compiled, and how tracked information is shown along with who receives the compiled information and what level of granularity conveyed. The ability to adjust the operational policies of the activity controller allows for optimized activity tracking, compiling, analyzing, and delivery to one or more recipients, such as an administrator, user, or other host.

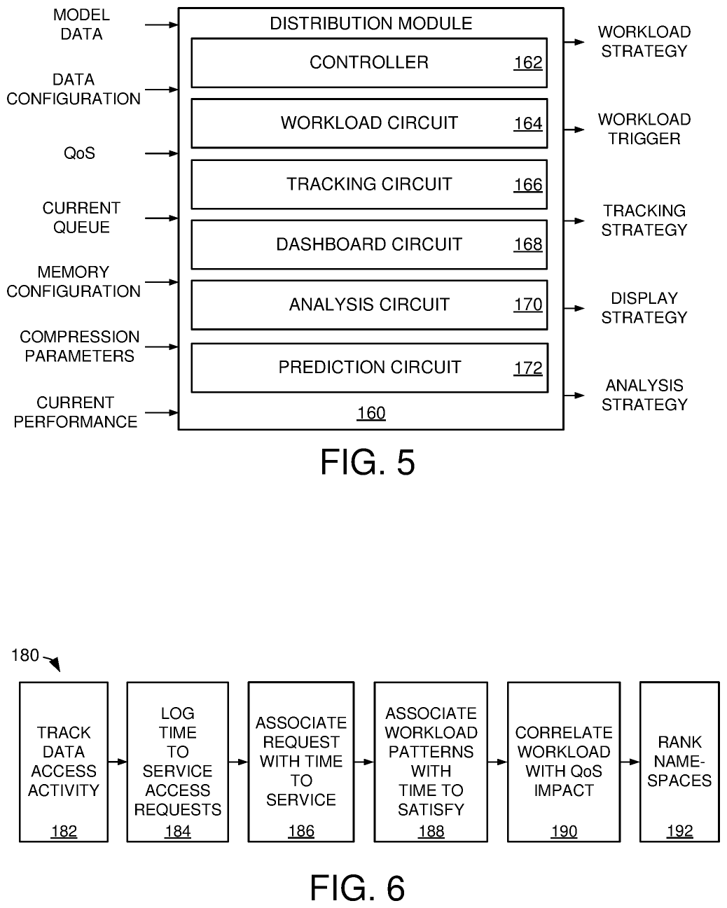

The activity controller 122 employs circuitry of a distribution module 160 to analyze current and predicted system workloads and performance to develop a tracking strategy that preemptively prescribes alterations to activity controller operational policies to provide optimal use of system resources to track data and system activity and provide heightened system performance, reliability, and/or security. FIG. 5 depicts an example distribution module 160 that can be employed in a data storage system in accordance with assorted embodiments to schedule and carry out intelligent tracking, analyzing, compiling, and delivery of data and system activity to one or more recipients. The module 160 can utilize one or more controllers 162 to translate a variety of input information into at least a workload detection strategy, a workload trigger, tracking strategy, display strategy, and analysis strategy that can be selectively, and concurrently, conducted to provide data access management optimization and system evaluation decentralization in view of dynamic data access workloads to various memories from numerous different users/hosts.

The module controller 162 may be a standalone circuit, such as a microprocessor or other programmable circuitry, resident anywhere in a data system, such as in a standalone node, network node, host, or data storage device. Regardless of where a controller 162, and module 160, is located in a data system, the data access activity to one or more memories can be monitored and logged along with the current memory configuration, security protocol, quality of service criteria, and data locations. The module controller 162 can input past logged information, such as error rate, data access latency, location of stale data, and garbage collection activity. While current and past information about the data system in which the module 160 is resident can be procured, the controller 162 may additionally refer to one or more data models pertaining to other data storage systems, memories, or host access activity.

While not limiting, the distribution module 160 can input assorted current and past logged conditions for one or more memories of a data storage system. For instance, the current physical block addresses of various calibration groups, the addresses of past data access errors and failures, the current physical and logical configurations of memory cells, and the pending data operations to the memory cells can be utilized individually, and collectively, to understand current namespace configurations and performance as well as future cell arrangements for namespace optimization.

The module controller 162 can operate alone to generate and maintain the various strategies to control current and future namespace workloads, configurations, and data access operations. However, some embodiments employ assorted circuitry to aid the module controller 162 in efficiently creating, altering, and executing the respective output strategies. A workload circuit 164 can assist the module controller 162 in translating the various input information into a workload strategy that has one or more triggers that correspond with a namespace operational policy change in order to mitigate, or eliminate namespace data access performance degradation. It is noted that while a namespace logical unit is discussed in association with workloads, such granularity is not limiting and workloads and various module strategies can be generated for different granularities, such as by data storage device, memory die, GCU, or source of data.

Although not required or limiting, the workload circuit 164 can generate and maintain multiple workload strategies for separate namespaces and/or memory die which allows for concurrent optimization of the respective memory cells through the execution of different operational policy changes prescribed by the respective operational strategies in response to detected, or predicted, activity that meets a predetermined workload trigger. For instance, a first namespace may have a first workload strategy generated by the workload circuit 164 that prompts the execution of a first set of data tracking, compilation, analysis, and/or data access operational policy changes, in response to a first trigger being met while a second namespace of a data storage device has a different workload strategy and triggers that prompt a different set of operational policy changes customized to the second namespace based on the workload to that namespace.

In order to induce customized and optimized system activity tracking, compilation, and delivery, the distribution module 160 can generate, maintain, and selectively execute a tracking strategy, display strategy, and operational strategy based on past, current, pending, and model data pertaining to system performance. A tracking circuit 166 can contribute to the various strategies by determining what system activity is tracked, how the activity is tracked, and what granularity is used to track the activity. The tracking circuit 166 may be considered an analysis engine, along with other circuitry of the module 160, as assorted aspects of the structural, operational, and policy of a data storage system can be evaluated to determine what is going to be tracked, and how. Some embodiments employ the analysis of the distribution module 160 in conjunction with analysis assigned to one or more hosts/users with respect to the tracked information compiled into a dashboard.

The ability to adapt what is tracked allows the tracking circuit 166 to customize what system resources are utilized and ensure expended resources are optimal for workloads to maintain, or increase, data access performance. For instance, the tracking circuit 166 can adapt tracking data accesses to a physical die of memory cells to tracking host-initiated data read and write requests to a namespace. In such example, the tracking circuit 166 prescribes to the tracking strategy that a first workload corresponds with logging each operation of each memory cell in a die, such as data refreshes, data reads, data writes, data mapping, data moves, garbage collection, and error corrections, while a second workload corresponds with logging each data read and each data write to a namespace.

The adjustment of both what is being tracked and the granularity of the tracking allows a tracking strategy to quickly pivot system resources so that dynamic workloads do not degrade overall system performance. The tracking circuit 166 may further determine what parameters, metrics, and statistics are tracked. As a non-limiting example, the tracking circuit 166 may prescribe that the source of a memory cell access be tracked, the permissions used to access data, how data was processed with compression and/or encryption, and various statistics, such as error rate, latency, time to completion, and physical block address of data accesses.

Through the adjustment of what activity is tracked and what metrics are tracked during an activity, the tracking circuit 166 can maintain the tracking strategy as customized and optimized to current and predicted system conditions. The prescription of granularity changes in the tracking strategy, such as logging activity to each memory cell, plane of memory cells, die of memory cells, data storage device, or logical group of memory cells, further creates a sophisticated and optimized strategy that accumulates sufficient volumes of information for the distribution module 160 to ascertain the status of the data storage system as well as potential vulnerabilities/opportunities to increase system performance and consistency.

With the tracking circuit 166 determining what information is tracked with what granularity and from what portions of a data storage system via the tracking strategy, a display strategy can similarly prescribe what tracked information is compiled into a dashboard, how information is displayed in the dashboard, and who is intended to see the dashboard. A dashboard circuit 168 can cooperate with the module controller 162 to generate and maintain the display strategy, which can evolve over time as the connected hosts/users change and/or the data and activity of the system changes. The predetermination of a display strategy by the distribution module 160 allows tracked information to be compiled into the visual form prescribed by the display strategy more efficiently than if tracked information was buffered until the module 160 assigned a dashboard type and the content to be shown in the dashboard.

The dashboard circuit 168 can provide additional guidance for the display strategy, such as what lens is used to convey tracked information to a host/user, how often tracked information is updated, the granularity of displayed information, if the tracked information is shown as an interactive dashboard, and if raw and/or translated information is displayed. An interactive dashboard allows a host/user to select and/or change the information being shown, such as between different granularities, activities, and/or activity sources. Raw tracked information may be unformatted while translated information is formatted for host/user consumption, which can involve simplified addresses, descriptions, resulting performance, and identification tags assigned by the distribution module 160 during tracking.

An analysis circuit 170 can translate the information gathered as directed by the tracking strategy and tracking circuit 166 into decisions that can be made by the distribution module 160 as well as recipients of a dashboard for assorted purposes. For instance, the analysis circuit 170 can prescribe various dashboard analysis purposes to one or more users/hosts, such as security, performance, or capacity purposes. The user/host analysis purpose assigned by the analysis strategy can have different granularities as well, such as analysis of information and decisions pertaining to current system status, potential vulnerabilities, and operational policy changes for each namespace, container, data storage device, memory die, or memory cell.

In some embodiments, the analysis circuit 170 determines who sees tracked information. The analysis circuit 170 can contribute to the display strategy by prescribing what information is shown to which host/user, which may be less than the entire volume of tracking information. The display strategy may further involve different views and tracked information delivery to different hosts/users that are customized to the permissions assigned to the receiving host/user, such as error mitigation, data mapping, background operation execution, and namespace memory cell allocation.

The execution of one or more strategies generated by the distribution module 160 provides a balance of data access request satisfaction speed with the scope, depth, and granularity of system activity tracking in a manner that meets a predetermined Quality of Service (QoS) standard, deterministic input/output window, or performance threshold. The ability to intelligently the satisfaction of track data access requests along with memory cell operations provides valuable information that allows the distribution module 160 to prescribe and/or execute memory cell operational policy changes that optimize current and/or future system performance, such as data access speed, reliability, and security. The correlation of intelligent system activity tracking with detected, and predicted, workloads to various portions of memory ensures system resources are utilized in an optimal manner.

The generation of assorted aspects of the workload and other strategies can provide sophisticated reactions to encountered namespace workloads as well as proactive actions that mitigate performance degradation due to activity tracking when conditions and/or activity change. The proactive generation of the workload and other strategies by the distribution module 160 allows the module controller 162 to execute workload, namespace, data access request, and memory cell operation control actions quickly and efficiently once a workload trigger is reached. In contrast, purely reactive generation of namespace and/or memory cell operation manipulation actions by the distribution module 160 would involve additional processing and time to evaluate and generate the proper action(s) to establish workload control and provide continued namespace data access performance to satisfy one or more predetermined expectations.

While the saving of processing overhead, the configuration of the respective workload and activity tracking strategies with both reactive and proactive actions provide intelligent long-term namespace and memory cell optimization that cannot be achieved with static operational policies or purely reactive generation of action(s) to control and optimize the operation of memory cells in view of workload. The generation of proactive actions and identifying future workload and namespace operational performance for the respective strategies is aided by a prediction circuit 172. A prediction circuit 172 can input assorted current and past operations, actions, and activity, along with model data from other memory, to forecast at least one future namespace operational condition, data access request, or data access performance.

The accurate prediction of memory, data access request, metadata, and namespace conditions along with data access performance allows the respective strategies generated by the distribution module 160 to have one or more operational policy adaptations to mitigate, or completely avoid, a forecasted future operational occurrence that can degrade system performance, reliability, or security. The prediction circuit 172 can further forecast how long different strategy actions will take for varying system conditions, which allows the module 160 to quickly adjust between different policy changes to provide a practical workload control and maintain operational performance without unduly stalling or degrading overall data storage system performance.

With the tracking strategy prescribing what system metrics, statistics, and activities to monitor while the display strategy prescribes how tracked information is shown to predetermined users/hosts/administrators, the distribution module 160 can adapt how system resources are used with respect to the actual, pending, and/or predicted workload to portions of a data repository, such as a namespace, physical memory die, range of PB As, or range of LB As. The gathering and display of assorted system information allows the distribution module 160 to analyze the information with the analysis circuit 170 and prescribe tracked activity analysis purposes to one or more decentralized users/hosts, which eases the burden of activity analysis on the module 160 and other centralized system processing components.

FIG. 6 depicts an example workload detection procedure 180 that can be carried out in a data storage system via a distribution module in accordance with various embodiments. Data accesses are tracked in step 182 by the distribution module. As such, the distribution module can track assorted data access metrics concurrently or sequentially. The overall time to service a data access request is logged by the distribution module in step 184. It is noted that the overall time to satisfy a data access request is not the only activity tracked in 182, but such activity tracking can be prioritized by redundantly monitoring and interpreting the elapsed time from submission of a data access request by a host to the return of data, in the case of a read request, or the writing of data to a namespace, in the case of a write request.

The logged time to service a data access request can be evaluated in isolation or with the service times of other data access requests to a namespace to determine how long a new data access request to a namespace would take to service. As a result of the logging of actually completed data access requests in step 184 along with the association of new data access requests with an estimated time to service, the distribution module can compile the workload for a namespace. That is, the combination of previously satisfied data access requests and estimated time to service new requests provides enough information for a distribution module to determine the workload for a namespace. Hence, the distribution module generates and maintains a workload value for each namespace that corresponds to how long a data access request takes to be satisfied. A namespace workload further corresponds to the memory cell operational performance of a namespace as well as the current channel and processor capabilities that service memory cells of a namespace.

With the logging of actual request satisfaction times in step 184 and the association of future requests with request satisfaction times in step 186, the distribution module can compile workload values over time for each namespace of a device/system. The tracking of workloads to various namespaces allows the distribution module to identify various workload patterns that reliably indicate future data access request satisfaction times, processing requirements, and buffer memory requirements in step 188. The combination of the determination of namespace workload and the association of workload patterns with future namespace time to satisfy a data access request provides ample information for the distribution module to correlate current namespace workload with an impact to predetermined namespace operational performance and/or power consumption expectations in step 190, such as QoS, deterministic window, error rate, and average data access latency.

Through the tracking of workloads and correlation of those workloads with impact to predetermined namespace operational performance, the distribution module can rank the various available namespaces in step 192 with the aid of the ranking circuit. Such namespace ranking can organize namespaces by availability, efficiency, reliability, read performance, or write performance. For instance, the distribution module can rank namespaces in step 192 by which namespaces can service a request most quickly (availability), with least processing consumption (efficiency), with least error rate (reliability), read request latency, average request service time, or write request latency. The ranking of namespaces allows the distribution module to generate and adjust operational strategy policy actions that provide the greatest opportunity to satisfy performance expectations in view of current and future predicted namespace workloads.

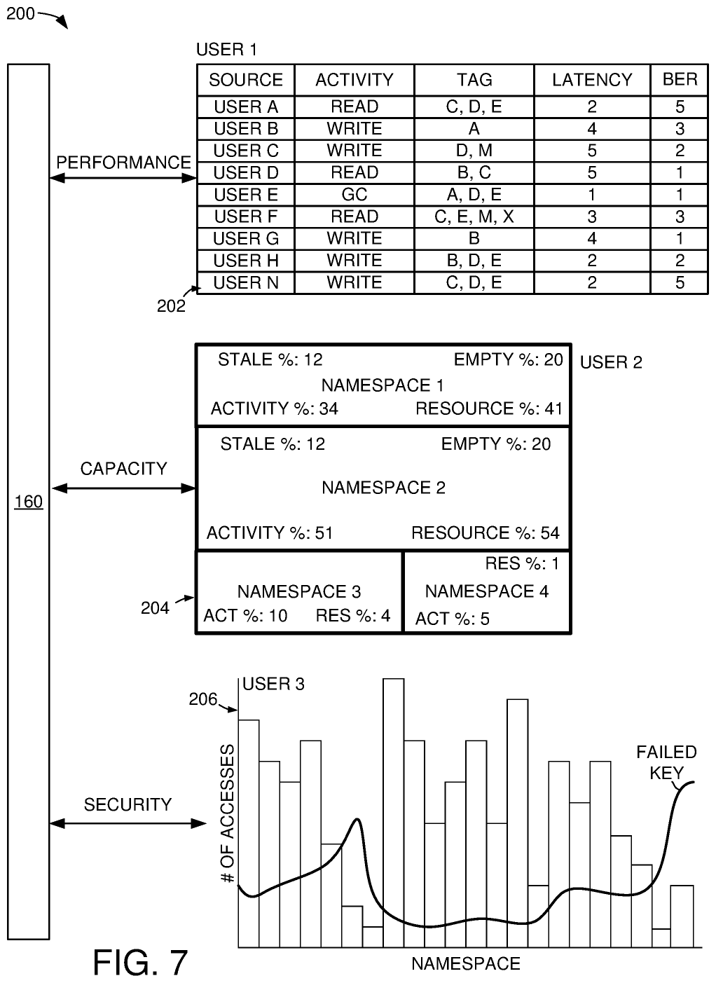

FIG. 7 depicts a block representation of portions of an example data system 200 in which assorted embodiments can be practiced. As part of a tracking strategy executed in combination with the display strategy, system workloads, system activity, and available resources can be detected to prompt the compilation and display of the first dashboard 202 to at least a first predetermined user/host/administrator (USER 1). The first dashboard 202 conveys an example grid view that displays raw and/or translated system information to various portions of memory concurrently. The distribution module 160 can alter what information is shown in the first dashboard 202 as well as whom has access to the information. Hence, the distribution module 160 can broadcast the first dashboard 202 to multiple different users, but with different information displayed in accordance with the user's security clearance and/or available resources to interpret the displayed information.

The decentralized distribution of the first dashboard 202, as prescribed by the distribution module 160, can correspond with different permissions and capabilities for the recipient host/user/administrator to interpret the dashboard information and execute portions of the operational strategy. For instance, different users can be given different permissions to analyze information from the first dashboard 202 and execute one or more policy changes dictated by the preexisting operational strategy, such as suspending background operations, altering the allocation of memory cells for a namespace, or prioritizing data access to a particular namespace to meet a guaranteed performance metric.

It is noted that the execution of a tracking strategy may accumulate raw information about an unlimited variety of system parameters, such as current and predicted error rates (BER), data access latency, overall time to complete a user-generated request, data access frequency, reference voltage calibration, and memory access request type (READ/WRITE). The raw information can be translated by the distribution module 160 into statistics, activities, and metrics that describe the status of portions of the data storage system, such as data write, data read, data mapping, data consolidation, garbage collection, background operation, security vulnerability, namespace access frequency, stale data locations, and failed security attack locations. The accumulation of raw information with, or without, translated system information allows the distribution module 160 to intelligently select future information gathering granularity and compile a variety of different types of dashboards with information, data, metrics, parameters, and statistics customized for the recipient user, in accordance with the predetermined display strategy, to optimize the user's ability to visually analyze and interpret the information of the dashboard.

While the distribution module 160 can send a similarly configured dashboard 202 to multiple different users/hosts for the same, or different, analysis purposes, various embodiments send differently configured dashboards to different users/hosts for the same, or different, analysis purposes. The non-limiting example of FIG. 7 conveys how the distribution module 160 compiles a map type dashboard 204 for a second user/host (USER 2) in accordance with display and analysis strategies. It is noted that the distribution module 160 can alter the existing grid type dashboard 202 displayed to the first user/host. The map type dashboard 204 illustrates the physical and/or logical location of memory and data along with the associated activity and resource levels.

Although not required or limiting, the second dashboard 204 has a namespace granularity set by the distribution module 160 where the percentage of overall system activity, the percentage of system resources consumed, the percentage of memory cells containing stale data, and the percentage of memory cells containing no user-generated data are simultaneously shown for each namespace. If the distribution module 160 was to change the granularity of the second dashboard 204, such as to memory cell level, memory die level, or logical container level, the activity (ACT), resource (RES), stale data, and empty cell information would be displayed for each memory cell, memory die, or logical container, respectively.

In some embodiments, the map type dashboard 204 conveys data access frequency for logical data addresses and/or physical data addresses. Such data access frequency can be depicted as colors, shading, symbols, or outlines to convey where data accesses are occurring over time. The illustration of data access frequency can be characterized as a memory cell heat map as more frequently accessed memory cells are considered hotter than less frequently accessed memory cells. Regardless of the analysis purpose associated with the map type dashboard 204, the illustration of a heat map can efficiently visually convey to a user/host how often memory cells are being accessed by host-generated data access requests as well as system-generated background operations, such as cell refreshes, cell reference calibrations, garbage collections, data mapping, and data movement.

The example second dashboard 204 conveys information to allow a recipient user/host to conduct memory capacity analysis purposes, such as determining where stale data is located for garbage collections, where duplicate data can be consolidated, distributing data to physical addresses to reduce hot memory cells, and if overprovisioned memory cells can be repurposed to replace or supplement other memory cells of a namespace, die, or container. By having a user/host analyze how the data capacity of a namespace, memory die, container, or data storage device can be optimized by altering one or more existing operational policies and/or stored data, other data storage system components can quickly carry out the changes prescribed by the user/host with minimal, if any, degradation in overall system performance, reliability, or security.

As shown by the third dashboard 206, tracked information can be compiled by the distribution module 160 into a graphical representation, in accordance with the display and analysis strategies, corresponding to a namespace granularity with the number of data accesses over time as well as the number of failed security and/or encryption key attempts over time. It is noted that other granularities can be conveyed by the third dashboard 206 as well as other raw and/or translated information in similar, or dissimilar, graphs. For instance, different graphs can each correspond with particular ranges of physical or logical data addresses while conveying different types of information, such as raw bit error rate, translated activity type, translated attempted third-party attacks, and raw number of connected hosts/users.

The ability to customize what tracked information is shown by a dashboard 202/204/206 in accordance with the display strategy complements the analysis strategy that assigns one or more analysis purposes to a recipient user/host. The graph type dashboard 206 is shown in FIG. 7 to be conducive to a security analysis purpose, such as finding past successful and unsuccessful third-party attacks, locating vulnerable physical and/or logical data addresses, and identifying when a security key needs to be changed or upgraded. While the graph type dashboard 206 can be used to convey other tracked information conducive to other analysis purposes, such as data access performance or data capacity, the overlay of multiple different graph styles, such as the line and bar graphs of dashboard 206, allows a user/host to visually identify where security activity has occurred and what reactions can optimize security operation, such as use a different key, move sensitive data, or allocate namespaces to different logical data addresses.

Through the execution of predetermined display and analysis strategies that compile information accumulated via a tracking strategy, the distribution module 160 can intelligently select assorted users/hosts to receive dashboards compiled with raw and/or translated system information customized to the user/host as well as the analysis purpose assigned to the respective decentralized users/hosts. It is contemplated that the distribution module 160 can customize the information tracked, compilation of dashboards, and distribution of dashboards to users/hosts with assigned analysis purposes based on detected and/or predicted system workloads. That is, the distribution module 160 can alter tracking, display, and analysis strategies based on system workloads so that system resources are optimally expended without degrading data access performance to any one data storage device, namespace, container, or memory die, which increases the system's capability to guarantee and satisfy performance over time, such as for QoS and deterministic windows.

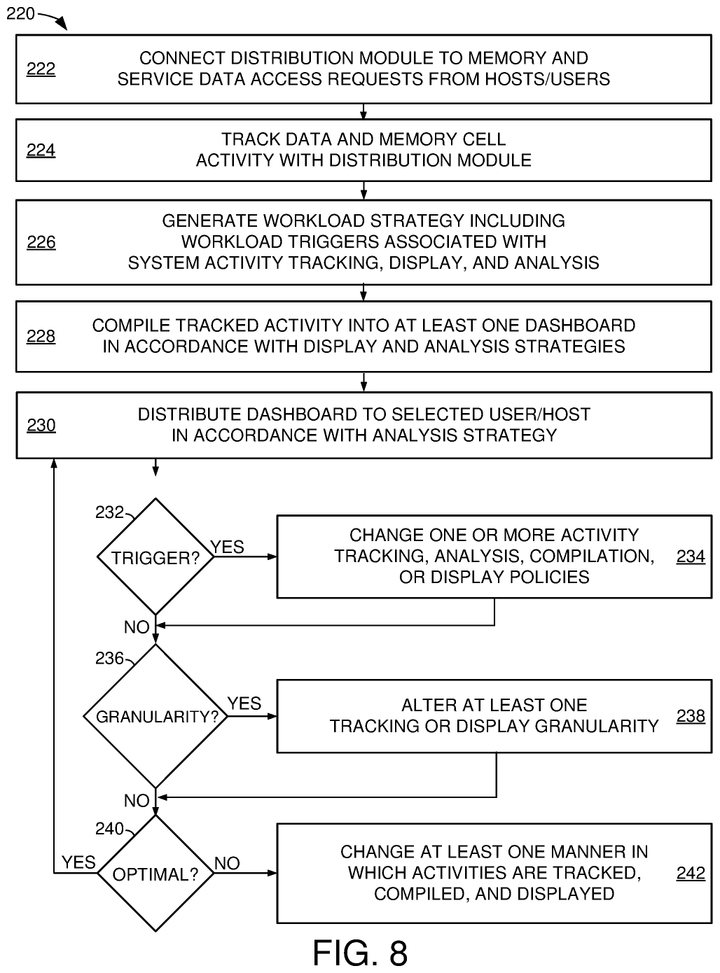

FIG. 8 conveys an example activity analysis routine 220 that can be carried out with the assorted embodiments of FIGS. 1-7 to control what data storage system activity is tracked, who sees the tracked information, how the tracked information is displayed, and what decentralized analysis purposes are to be satisfied to optimize system performance, reliability, and security. Connection of a distribution module to a memory, such as a solid-state data storage device, allows for the initialization of the memory to service data access requests from hosts/users external to the memory, such as a third-party human user, in step 222. It is contemplated that the distribution module may oversee, or dictate, the establishment of various logical units, such as overprovisioned groups, garbage collection units, and zoned namespaces, that can occupy any physical and logical data block addresses in one or more data storage devices, die of memory cells, and planes of memory cells.

Activity to the assorted memory cells is subsequently tracked by the distribution module in step 224 to determine the capabilities, current performance, and operational configuration of the memory cells as well as the assorted logical units. It is noted that the distribution module can track any number of different data access and memory behavior metrics over time. The tracked data access activity and memory characteristics compiled by the distribution module from step 224 allows the distribution module to assign workload values to various groups, such as the respective namespaces, that correspond with at least the volume of data accesses conducted for a given length of time. An assigned workload value may be more sophisticated, as directed by the distribution module, and can include a compilation of memory cell efficiency and/or reliability with availability. The ability to adapt the tracking of activity for a memory cell and/or logical unit and the generation of a workload value for allows the distribution module to conduct more, or less, rigorous processing and time to determine how much system capability is occupied by data access operations initiated by external hosts/users as well as background memory operations, such as garbage collection, memory refresh, and data mapping.

The detected workloads are monitored over time by the distribution module while a workload strategy is generated in step 226. The workload strategy establishes when various portions of memory can benefit from reactive and/or proactive operational policy changes that provide data access performance manipulation and sets a workload trigger to prompt execution of activity tracking, display, or analysis change in step 226. It is contemplated that the workload strategy, and established triggers, can correspond with activity tracking, system performance analysis, and/or system metric compilation that intelligently conveys what is occurring in the data storage system to one or more hosts/users. The generation of strategies by the distribution module in step 226 may further involve generating a tracking strategy that dictates what system information to log and compile as well as a display strategy that dictates who sees what information in what manner.

The correlation of the various system activity and operational strategies with current, pending, and predicted workloads provides intelligent use of system resources to monitor, log, compile, and analyze the flow of data, use of memory cells, and data handling operations. In accordance with the tracking and display strategies, tracked system activity is compiled into a dashboard in step 228 in accordance with the predetermined display and analysis strategies. As discussed above, the display strategy, in combination with the collection of activities, statistics, and metrics as prescribed by the tracking strategy, can convey multiple different dashboards, different information, and different information granularities to different hosts/users. For instance, the distribution module in step 228 can log system activity corresponding to particular activities, data source, data destination, security handling, compression handling, or tag assigned by the distribution module prior to displaying such information as part of a dashboard that can provide raw, untranslated information or information translated into a visually optimized format, such as a graph or map.

Step 230 proceeds to distribute the dashboards compiled in step 228 to selected, decentralized user/hosts with one or more analysis purposes assigned by the analysis strategy. As a result of step 230, various decentralized users/hosts of the data storage system can conduct at least visual inspection of one or more dashboards to render at least one analysis conclusion that is returned to the distribution module. An analysis conclusion can be any modification to existing operational policy based on the information conveyed by the dashboard exposed to the user/host, such as changes to security settings, data access performance settings, data organization and configuration settings, or logical memory allocations into namespaces and/or containers.

At any time after the generation of workload trigger(s) in step 226, decision 232 evaluates if there is any indication that a triggering event will transpire, such as in predetermined workload triggers, detected system activity, and/or predicted system performance volatility. If a triggering event is detected, or predicted, step 234 activates one or more tracking, display, and/or analysis policy changes in accordance with established strategies to accommodate the triggering workload. For example, step 234 can alter what activity is tracked, where activity is tracked, how tracked information is compiled, how tracked information is analyzed, and how information is displayed to what hosts/users.

With no triggering event present or at the conclusion of step 234, routine 220 evaluates if system activity tracking, display, and/or analysis can be optimized by altering granularity in decision 236. That is, decision 236 can hypothetically evaluate with the distribution module how much system resources will be expended, or saved, by changing the granularity in which activities are tracked, logged, compiled, analyzed, or displayed. It is noted that granularity can be characterized as the resolution of system information, such as by memory cell, die of memory cells, data storage device, namespace, GCU, most frequently accessed memory cells, least frequently accessed memory cells, or highest error rate.

A change in granularity prompts step 238 to alter at least one system tracking, activity compilation, activity analysis, or activity display. With the granularity altered, or if no granularity change is in order from decision 236, decision 240 evaluates with the distribution module if the current activity tracking, compilation, analysis, and display are optimal. The evaluation of decision 240 by the distribution module can monitor past and existing system resource expenditures on system activity tracking and display to determine if the execution of future activity tracking and display is optimal. It is noted that optimal can be characterized as utilizing system resources to carry out system activity tracking, compilation, and/or display without actually degrading data access performance for the system or jeopardizing the performance, reliability, or security of satisfying future data access operations.

In the event the distribution module determines that a sub-optimal system status is present, step 242 alters at least one manner in which activities are tracked, compiled, analyzed, compiled, and/or displayed. Step 242 may, but is not required to, change the actual prescribed actions of one or more strategies in order to optimize the tracking, compilation, analyzing, and display of system activity. Otherwise, step 242 may temporarily suspend one or more distribution module strategies in order to maintain optimal system tracking, compilation, and display to one or more hosts/users.

Through the various embodiments of a distribution module, a graphical user interface is created and maintained that enables a user/host to visually assess the status of a system, such as locations in which data sets are stored on and among various data storage devices. Embodiments can provide multiple alternative views, such as grid, map, and graph views that generally show representations of the data storage system. It is contemplated that a display strategy conveys information in a list view in a dashboard, which generally lists tabulated data. As a result, a user can optimally browse both large and small data sets.

By allowing the user/host to switch between the different dashboard configurations, such as between grid and list views with a single mouse click or other activation, the user/host can quickly determine whether a particular data set is large or small and provide an optimal mechanism for obtaining desired details regarding each. While not required, the list view is compact and shows each record as a single row, which is useful to quickly scan and compare large sets of data while a grid view presents more detail and often a visual representation of the record and is suited for browsing small data sets, as well as larger sets where the higher fidelity data representation is necessary.

While not limiting, in at least some cases, a data storage system has an analysis engine as part of the storage device or system controller functionality. This might be a software/firmware routine operated in the background that monitors ongoing system activity and makes available data structures with the types of data that may be requested. The system would further include API style code that would generate a display interface on a display device of each authorized user. Search terms could be entered by the user/host for a particular search and the results displayed or transferred in any suitable format. The system might be considered analogous to a search engine style device, but it would be system specific. Maps or other graphical information might be incorporated into the interface to provide an authorized user with a graphical representation of the system status and performance. It is contemplated that the main system would be a keyboard/text interface, but this is not required as other interface options could be used including audio-to-text mechanisms.

With the intelligent utilization of a distribution module in accordance with assorted embodiments, a balance can be established and maintained between system resources expended on logging, displaying, and analyzing activity compared to operational policy changes that can optimize system performance and resource allocation. That is, less system resources can be expended on activity tracking, display, and/or analysis to provide short-term data access performance capabilities in some instances while more system resources can be expended on tracking and/or displaying system activity to provide the distribution module an accurate understanding of the status of at least one memory, which leads to operational policy changes that can ensure optimized data access performance, reliability, and security. The correlation of workloads to activity tracking, compilation, and display further provides a balance of system resource expenditure with real-time data access performance.

What is claimed is:

1. A method comprising:
tracking data access operations to a memory with a distribution module;
translating the tracked data access operations into at least one activity with the distribution module;
creating a first visual representation of the at least one activity and a second visual representation of the at least one activity with the distribution module;
distributing the first visual representation to a first user and the second visual representation to a second user, the first user and second user respectively selected by the distribution module;
analyzing the first visual representation by the first user for a first purpose assigned by the distribution module; and
analyzing the second visual representation by the second user for a second purpose assigned by the distribution module.

2. The method of claim 1, wherein the first visual representation is a grid type dashboard displaying the at least one activity in accordance with a display strategy generated by the distribution module.

3. The method of claim 1, wherein the first visual representation is a map type dashboard displaying the at least one activity in accordance with a display strategy generated by the distribution module.

4. The method of claim 1, wherein the first visual representation is a graph type dashboard displaying the at least one activity in accordance with a display strategy generated by the distribution module.

5. The method of claim 1, wherein the first and second visual representations are different.

6. The method of claim 1, wherein the first and second purposes are different.

7. The method of claim 1, wherein the first and second purposes are each assigned by an analysis strategy generated by the distribution module prior to creating the first visual representation or the second visual representation.

8. The method of claim 1, wherein the first user returns a first operational policy change as a result of the first purpose and the second user returns a second operational policy change as a result of the second purpose, the operational policy changes being different.

9. A method comprising:
generating a tracking strategy with a distribution module;
tracking data access operations to a memory in accordance with the tracking strategy;
generating a display strategy with the distribution module;
translating the tracked data access operations into at least one activity with the distribution module;
creating a first visual representation of the at least one activity and a second visual representation of the at least one activity in accordance with the display strategy;
generating an analysis strategy with the distribution module;
distributing the first visual representation to a first user and the second visual representation to a second user, the first user and second user respectively selected by the analysis strategy;
analyzing the first visual representation by the first user for a first purpose assigned by the analysis strategy; and
analyzing the second visual representation by the second user for a second purpose assigned by the analysis strategy.

10. The method of claim 9, wherein the first visual representation is altered by the distribution module to display an additional raw tracked system information.

11. The method of claim 9, wherein the first visual representation is altered by the distribution module to display an additional translated tracked system information.

12. The method of claim 9, wherein the first visual representation is altered in response to a workload to the memory detected by the distribution module.

13. The method of claim 9, wherein the first visual representation is altered by the distribution module from a first granularity to a different second granularity.

14. The method of claim 13, wherein the first granularity is namespace level and the second granularity is memory die level.

15. The method of claim 13, wherein the first granularity is memory cell level and the second granularity is container level.

16. A method comprising:
tracking data access operations to a memory with a distribution module;
translating the tracked data access operations into at least one activity with the distribution module;
creating a first visual representation of the at least one activity and a second visual representation of the at least one activity with the distribution module;
distributing the first visual representation to a first user and the second visual representation to a second user, the first user and second user respectively selected by the distribution module;
analyzing the first visual representation by the first user for a first purpose assigned by the distribution module;
analyzing the second visual representation by the second user for a second purpose assigned by the distribution module; and
altering the first purpose to a third purpose in response to a change in the tracked data access operations, the third purpose being different than each of the first and second purposes.

17. The method of claim 16, wherein the first purpose involves identifying a namespace that can have increased data access performance with one or more alterations to an existing operational data access policy.

18. The method of claim 16, wherein the second purpose involves identifying a namespace that is vulnerable to a third-party attack.

19. The method of claim 16, wherein the third purpose involves identifying a namespace that can have increased data capacity with one or more alterations to an existing data storage configuration.

20. The method of claim 16, wherein the first purpose is to identify a data storage location where one or more alterations to an existing operational data access policy can decrease an average data access latency for a namespace.
